(19) United States
(12) Patent Application Publication
(10) Pub. No.: US 2024/0087477 A1
(43) Pub. Date: Mar. 14, 2024

(54) Generation device of star projector light

(71) Applicant: Fangyi LI, Dongguan City (CN)

(72) Inventor: Fangyi LI, Dongguan City (CN)

(21) Appl. No.: 18/045,227

(22) Filed: Oct. 10, 2022

(30) Foreign Application Priority Data
Sep. 9, 2022 (CN) 2022111015753

(51) Int. Cl. G09B 27/04

(52) U.S. Cl. CPC G09B 27/04

(57) ABSTRACT

A light generation device having a pedestal, an imaging lens, and at least one light source generator, wherein the light source generator generates light beams, the light beams are irradiated into a lined condensing total internal reflection lens, the lined condensing total internal reflection lens reflects and diffracts the light beams to the imaging lens via lines and patterns on the lined condensing total internal reflection lens, and nebula projection patterns are formed; the device further comprising a drive motor and a star projector, the drive motor is provided at a side of the lined condensing total internal reflection lens and an output end of the drive motor is connected with an outer side of the lined condensing total internal reflection lens, the lined condensing total internal reflection lens reflects diffracted lights to the pedestal during rotation and dynamic nebula projection effects are formed.

### TECHNICAL FIELD

The present invention belongs to the technical field of lighting, and specifically a generation device of star projector light.

### BACKGROUND TECHNOLOGY

Lighting is to use a variety of light sources to illuminate working and living places to ease our production and life. Lighting is a necessity. With progress of the society, there are a plenty of lighting methods, purposes of lighting are different, and for lighting products, besides basic illumination demands, more and more recreation and healthcare demands are attached. With development of the technology, the lighting product has now stronger functions, and commercially there are a lot of illumination lights supporting color adjustment and Bluetooth speakers.

In recent years, with development of astronomy, curiosity on the space and unknown universe is gradually deepening. In addition, the intelligent light market is developing fast, a plurality of intelligent lights capable of light adjustment, color adjustment and being in rhythmic movement with music appeared, what's more, colors of the lights can resemble nebula.

Technical solutions in the prior art: in the prior art, usually only with light sources, thermal disseminators for light sources, condensing lenses and lens supports, refraction sheets and light transmission covers star projection effects can be realized, and cost for the foregoing structures is high, ordinary consumers cannot afford, and production and assembly thereof is complex and the projection lacks definition, as a result user experience is poor; furthermore, a utilizing rate of the light sources after several layers of lenses is low, therefore, for brightness and good user experience, current for brightness of the light sources shall be increased, consequently, a large dissemination system is required, a large space is required for dissemination, therefore, design of appearances and structures of the products is subject to many limitations and the products are not pleasant enough in looking. What's more, it is necessary to energize the light sources, so the light sources are fixed, and to generate moving nebulae refraction sheets driven by a motor are used, therefore, to construct natural nebula projection effects, areas of the refraction sheets shall be increased, finally, the star projectors are of large sizes, which limits use circumstances, increases production cost, reduces usage efficiency and makes it difficult to carry them.

For example, a Chinese patent with a publication number of CN101276523B has disclosed a projection device for generating moving starry sky and cloud effects, comprises a device for generating cloud effects with at least one incoherent light source, a device for generating moving starry sky with at least one coherent light source and a device for adjusting and providing power supply. The device for generating cloud effects with at least one incoherent light source comprises at least one pair of condensing lenses and at least one interference filter rotated by an electric motor, the at least one interference filter is placed in between the at least one pair of condensing lenses. The device for generating moving starry sky with coherent light sources comprises an optical grating rotated by an electric motor and at least one diffraction optical component provided between the at least one coherent light source and the optical grating. It can be seen that in the prior art structures of the star projection device are quite complicated, adjustment of the device is not easy and when it is necessary to project on a large area, size of the star projection device is multiplied and user experience is not good.

### SUMMARY OF INVENTION

A purpose of the present invention is to provide a generation device for star projection light, to address the problems raised in the background.

To realize the foregoing purpose, the present invention provides the following technical solution:
a generation device for star projection light comprising:
a pedestal, an imaging lens, at least one light source generator, a lined condensing total internal reflection lens, a drive motor and a star projector;
wherein both the imaging lens and the at least one light source generator are installed on the pedestal,
wherein the lined condensing total internal reflection lens is provided on an upper portion of the at least one light source generator, and the imaging lens is provided on an upper portion of the lined condensing total internal reflection lens, lines and patterns are provided on a surface of the lined condensing total internal reflection lens,
wherein the at least one light source generator generates light beams, the light beams enter the lined condensing total internal reflection lens, the lined condensing total internal reflection lens refracts and reflects the light beams to the pedestal through the lines and patterns on the lined condensing total internal reflection lens and nebula projection patterns are formed;
wherein the drive motor is provided at a side of the lined condensing total internal reflection lens and an output end of the drive motor is connected with an outer surface of the lined condensing total internal reflection lens, the drive motor is configured to drive the lined condensing total internal reflection lens to rotate, the lined condensing total internal reflection lens refracts lights during rotation and irradiates the lights to the pedestal and dynamic nebula projection effects are formed;
the star projector is provided beside the lined condensing total internal reflection lens and configured to generate star projection, and the star projection generated by the star projector is shot on the pedestal and star projection is formed.

On the basis of the foregoing technical solution, the present invention further provides the following optional technical solutions:

In one of the optional technical solutions: an indentation is provided at a bottom portion of the lined condensing total internal reflection lens, at least one light source of the at least one light source generator is provided in the indentation, light emitted by the at least one light source of the at least one light source generator enters the lined condensing total internal reflection lens through the indentation.

In one of the optional solution: the lined condensing total internal reflection lens is configured to be conical, and a diameter of the indentation at the bottom portion of the lined condensing total internal reflection lens is smaller than a diameter of the lines and patterns.

In one of the optional technical solution: the lined condensing total internal reflection lens is provided with two slant heights and an angle included by the two slant heights ranges from 10 to 120 degrees.

In one of the optional technical solution: an output shaft of the drive motor is at the same horizontal line as a central axis of the lined condensing total internal reflection lens, an upper cartridge and a lower cartridge casing are respectively provided on an upper portion and a lower portion of the lined condensing total internal reflection lens, by fitting the upper cartridge casing and the lower cartridge casing a fixing piece is formed, the lined condensing total internal reflection lens is installed in the fixing piece and a gap is left at a side of the fixing piece, ring-shaped teeth are provided circumferentially at an edge of the lined condensing total internal reflection lens, and gears are provided on the output shaft of the drive motor and the gears engage with the ring-shaped teeth at the gap.

In one of the optional technical solution: a control circuit board is provided on the pedestal, a control system is loaded on the control circuit board, the control system comprises a motor control unit, a light source generator control unit and a laser control unit, wherein, the motor control unit is connected with the drive motor and controls a rotation speed of the drive motor, and by controlling power of the drive motor with the motor control unit moving speed of the nebula in the nebula projection can be adjusted; the light source generator control unit is connected with the light source generator, and is configured to control working states of the at least one light source generator, the laser control unit is connected with the star projector, and by controlling the star projector with the laser control unit illumination of stars in the star projection can be adjusted.

In one of the optional technical solution: an ambient light generator is provided on the pedestal, and the ambient light generator is provided at a lower portion of the lower cartridge casing and emits lights to assist the lined condensing total internal reflection lens to form star projection.

Compared with the prior art, beneficial effects of the present invention are:
1. For the star projection device provided in the present invention, light beams generated by the at least one light source generator are irradiated on the patterned surface of the lined condensing total internal reflection lens, and then emitted from the patterned surface of the lined condensing total internal reflection les, finally enter the imaging lens and moving nebula projection is formed; compared with the prior art, a lot of parts are saved, space that the parts occupy is reduced substantially, production cost is reduced and volume of the projection device is reduced;
2. In the present invention, with the motor drive mechanism the lined condensing total internal reflection lens can rotate for 360 degrees, and a rotation shaft of the motor drive mechanism is located at the same horizontal line as a central axis of the lined condensing total internal reflection lens, and when the lined condensing total internal reflection lens rotates the star projection formed rotates accordingly; compared with the prior art, a larger projection area can be obtained. So it can be known that, when obtaining the same projection area, the diameter of the lined condensing total internal reflection lens is at least 50% smaller than the diameter of the interference filter in the prior art, so that the volume of the star projection device can be reduced significantly, the cost is reduced, the effect is enhanced and user experience improved too.

### BRIEF DESCRIPTION OF DRAWINGS

FIG. 1 is a schematic diagram showing entire structures of the generation device provided in an embodiment of the present invention.

FIG. 2 is a structural diagram showing the control system as provided in an embodiment of the present invention.

Markups in the drawings: pedestal 1, imaging lens 2, light source generator 3, lined condensing total internal reflection lens 4, indentation 41, drive motor 5, lower cartridge casing 6, laser generator 7, upper cartridge casing 8, optical grating 9, ambient light generator 10 and star projector 11.

### EMBODIMENTS

To make purposes, technical solutions and advantages of the present invention more clear, hereinafter a detailed description will be given to the present invention with reference to the accompanying drawings and the embodiments; in the accompanying drawings or the specification, similar or identical parts are labeled by the same number, and during actual application, shapes, thickness and height of the parts can be enlarged or reduced. The embodiments listed in the present invention are only intended to describe the present invention rather than limit the scope of the present invention. Any obvious modification or variation to the present invention shall not deviate from the spirit and the scope of the present invention.

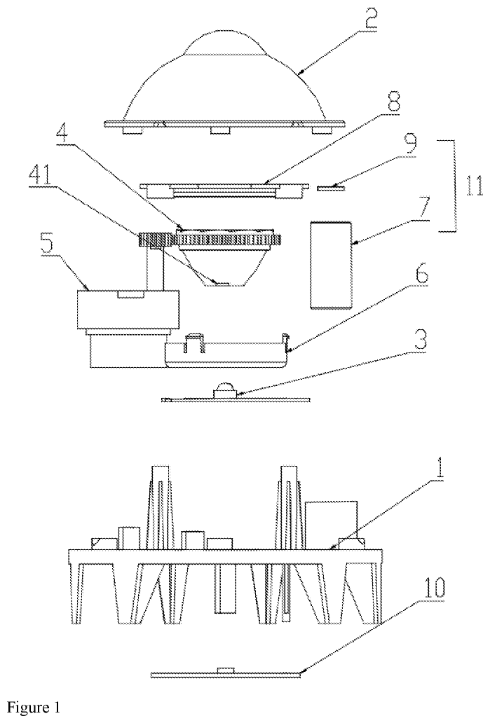

In an embodiment, as shown in FIG. 1, a generation device of star projection light, comprises a pedestal 1, an imaging lens 2, and at least one light source generator 3, both the imaging lens 2 and the at least one light source generator 3 are installed on the pedestal 1, a lined condensing total internal reflection lens 4 is provided on the at least one light source generator 3, and lines and patterns are provided on a surface of the lined condensing total internal reflection lens 4, the at least one light source generator 3 can generate light beams, the light beams enter the lined condensing total internal reflection lens 4, while the lined condensing total internal reflection lens 4 diffracts and emits the light beams onto the pedestal through the lines and patterns on the lined condensing total internal reflection lens 4, and nebula projection patterns are formed; the device further comprises a drive motor 5 and a star projector 11, the drive motor 5 is provided at a side of the lined condensing total internal reflection lens 4 and an output end of the drive motor 5 is connected with an outer surface of the lined condensing total internal reflection lens 4, the drive motor 5 is configured to rotate the lined condensing total internal reflection lens 4, the lined condensing total internal reflection lens 4 diffracts the light beams and emits the light beams onto the pedestal 1 and dynamic nebula projection effects are formed; the star projector 11 is provided at a side of the lined condensing total internal reflection lens 4 and is configured to generate star projection, the star projection generated by the star projector 11 is emitted onto the pedestal 1 and a starry sky projection is formed;

In the present embodiment, by rotation of the lined condensing total internal reflection lens 4 and the star projector effects of a starry sky light can be achieved, and by rotation of the lined condensing total internal reflection lens 4 a projection surface can be increased, so that a size of the present device is significantly reduced, the cost is reduced, the effect is enhanced and user experience is improved;

In an embodiment, as shown in FIG. 1, an indentation 41 is provided at a bottom portion of the lined condensing total internal reflection lens 4, at least one light source of the light source generator 3 is located in the indentation 41, so that light emitted by the at least one light source of the light source generator 3 enters the lined condensing total internal reflection lens 4 through the indentation 41;

In an embodiment, as shown in FIG. 1, the lined condensing total internal reflection lens 4 is configured to be conical, a diameter of the indentation 41 at the bottom portion of the lined condensing total internal reflection lens 4 is smaller than a diameter of the lines and patterns; the at least one light source of the light source generator is provided in the indentation 41, the light beams scatter and enter the lined condensing total internal reflection lens 4 so that projection surfaces are increased; wherein, two slant heights are provided on the lined condensing total internal reflection lens 4 and an angle included by the two slant heights ranges from 10 degrees to 120 degrees.

In one embodiment, as shown in FIG. 1, an output shaft of the drive motor 5 is located at the same horizontal line as a central axis of the lined condensing total internal reflection lens 4, a lower cartridge casing 6 and an upper cartridge casing 8 are provided respectively at an upper portion and a lower portion of the lined condensing total internal reflection lens 4, by fitting the lower cartridge casing 6 and the upper cartridge casing 8 a fixing piece can be formed, the lined condensing total internal reflection lens 4 is installed in the fixing piece and a gap is provided at a side of the fixing piece, ring-shaped teeth are provided circumferentially at an edge of the lined condensing total internal reflection lens 4, a gear are provided at the output shaft of the drive motor 5, and the gear engages with the ring-shaped teeth at the gap; by engagement between the gear and the ring-shaped teeth the drive motor 5 can realize rotation of the lined condensing total internal reflection lens 4, the nebula is dynamic, and by configuration of the gap interference can be avoided.

In an embodiment, as shown in FIG. 1, a light source circuit board is provided at a lower side of the light source generator 3, and a fixing slot is provided at a bottom portion of the lined condensing total internal reflection lens 4, the light source circuit board is installed in the fixing slot, so when the light beams from the light source generator 3 are irradiated onto the lined condensing total internal reflection lens 4 and the drive motor 5 drives the lined condensing total internal reflection lens 4 to rotate, the light source circuit board remains unchanged;

In an embodiment, as shown in FIG. 1, the star projector comprises a laser generator 7 and an optical grating 9, wherein a fixing groove is provided at an end portion of the laser projector 7 facing the imaging lens 2, the optical grating 9 is installed in the fixing groove, a laser transmission opening is reserved in the fixing groove; laser emitted by the laser generator 7 passes the optical grating 9 and the laser transmission opening and generates star projection on the imaging lens 2; wherein a thermal disseminator for disseminating heat by air flow is provided at an outer side of the laser generator 7.

In an embodiment, as shown in FIG. 1, an ambient light generator 10 is further provided on the pedestal 1, the ambient light generator 10 is provided at a lower portion of the lower cartridge casing 6 and emits light to assist the lined condensing total internal reflection lens 4 to generate star projection.

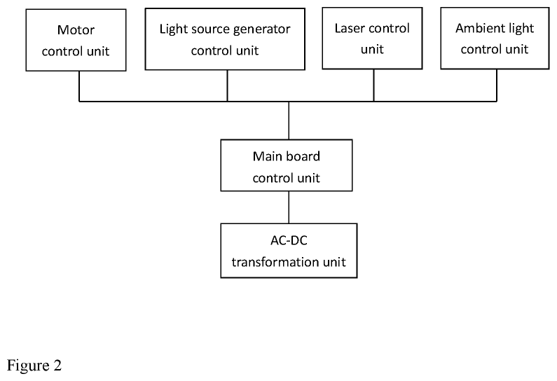

In an embodiment, as shown in FIG. 2, a control circuit board is further provided on the pedestal 1, a control system is loaded on the control circuit board, wherein the control system comprises a motor control unit, a light generator control unit and a laser control unit, wherein the motor control unit is connected with the drive motor 5 and controls a rotation speed of the drive motor 5, with the motor control unit power of the drive motor 5 can be controlled so as to adjust moving speed of the nebula in the nebula projection; the light source generator control unit is connected with the light source generator 3, and is configured to control working states of the light source generator 3, the laser control unit is connected with the star projector 11, and with the laser control unit the star projector 11 can be controlled so as to adjust illumination of stars in the star projection.

In an embodiment, as shown in FIG. 2, an ambient light control unit, an AC-DC transformation unit and a main board control unit are further provided in the control system, wherein the ambient light control unit is connected with the ambient light generator 10 and controls working states of the ambient light generator 10; the AC-DC transformation unit is configured to rectify the circuit and after rectification supplies power to the control circuit; and the main board control unit is configured to control working states of each of the units.

The foregoing are only some embodiments of the present disclosure, however the scope of the present disclosure is not limited to the embodiments given here, any one skilled in the art can come up with changes or substitutions with the technical scope disclosed in the present invention, and all the changes and substitutions are covered in the protection scope of the present invention. Therefore, the protection scope of the present invention shall be defined by the protection scope of the claims.

1. A generation device for star projection light comprising:
a pedestal, an imaging lens, at least one light source generator, a lined condensing total internal reflection lens, a drive motor and a star projector;
wherein both the imaging lens and the at least one light source generator are installed on the pedestal,
wherein the lined condensing total internal reflection lens is provided on an upper portion of the at least one light source generator, and the imaging lens is provided on an upper portion of the lined condensing total internal reflection lens, lines and patterns are provided on a surface of the lined condensing total internal reflection lens,
wherein the at least one light source generator generates light beams, the light beams enter the lined condensing total internal reflection lens, the lined condensing total internal reflection lens refracts and reflects the light beams to the pedestal through the lines and patterns on the lined condensing total internal reflection lens and nebula projection patterns are formed;
wherein the drive motor is provided at a side of the lined condensing total internal reflection lens and an output end of the drive motor is connected with an outer surface of the lined condensing total internal reflection lens, the drive motor is configured to drive the lined condensing total internal reflection lens to rotate, the lined condensing total internal reflection lens refracts lights during rotation and irradiates the lights to the pedestal and dynamic nebula projection effects are formed; the star projector is provided beside the lined condensing total internal reflection lens and configured to generate star projection, and the star projection generated by the star projector is shot on the pedestal and star projection is formed.

2. The generation device for star projection light according to claim 1, wherein an indentation is provided at a bottom portion of the lined condensing total internal reflection lens, at least one light source of the at least one light source generator is provided in the indentation, light emitted by the at least one light source of the at least one light source generator enters the lined condensing total internal reflection lens through the indentation.

3. The generation device for star projection light according to claim 1, wherein the lined condensing total internal reflection lens is configured to be conical, and a diameter of the indentation at the bottom portion of the lined condensing total internal reflection lens is smaller than a diameter of the lines and patterns.

4. The generation device for star projection light according to claim 3, wherein the lined condensing total internal reflection lens is provided with two slant heights and an angle included by the two slant heights ranges from 10 to 120 degrees.

5. The generation device for star projection light according to claim 3, wherein an output shaft of the drive motor is at the same horizontal line as a central axis of the lined condensing total internal reflection lens, an upper cartridge and a lower cartridge casing are respectively provided on an upper portion and a lower portion of the lined condensing total internal reflection lens, by fitting the upper cartridge casing and the lower cartridge casing a fixing piece is formed, the lined condensing total internal reflection lens is installed in the fixing piece and a gap is left at a side of the fixing piece, ring-shaped teeth are provided circumferentially at an edge of the lined condensing total internal reflection lens, and gears are provided on the output shaft of the drive motor and the gears engage with the ring-shaped teeth at the gap.

6. The generation device for star projection light according to claim 1, wherein a control circuit board is provided on the pedestal, a control system is loaded on the control circuit board, the control system comprises a motor control unit, a light source generator control unit and a laser control unit, wherein, the motor control unit is connected with the drive motor and controls a rotation speed of the drive motor, and by controlling power of the drive motor with the motor control unit moving speed of the nebula in the nebula projection can be adjusted; the light source generator control unit is connected with the light source generator, and is configured to control working states of the at least one light source generator, the laser control unit is connected with the star projector, and by controlling the star projector with the laser control unit illumination of stars in the star projection can be adjusted.

7. The generation device for star projection light according to claim 6, wherein an ambient light generator is provided on the pedestal, and the ambient light generator is provided at a lower portion of the lower cartridge casing and emits lights to assist the lined condensing total internal reflection lens to form star projection.
